(19) United States
(12) Patent Application Publication
(10) Pub. No.: US 2019/0084237 A1
(43) Pub. Date: Mar. 21, 2019

(54) BUILDING APPARATUS AND COLLECTING APPARATUS

(71) Applicant: MIMAKI ENGINEERING CO., LTD., Nagano (JP)

(72) Inventor: Kyohei Maruyama, NAGANO (JP)

(73) Assignee: MIMAKI ENGINEERING CO., LTD., Nagano (JP)

(21) Appl. No.: 16/135,007

(22) Filed: Sep. 19, 2018

(30) Foreign Application Priority Data
Sep. 20, 2017 (JP) 2017-180219

(51) Int. Cl. B29C 64/364; B33Y 30/00; B33Y 40/00; B29C 64/20

(52) U.S. Cl. CPC B29C 64/364; B29C 64/20; B33Y 40/00; B33Y 30/00

(57) ABSTRACT

To provide a building apparatus that can collect ink and mist thereof that may remain in a building area. The building apparatus includes an exhaust duct that has an exhaust port arranged above a nozzle face of an ejection head that ejects an UV curable ink, the exhaust duct for sucking out an air from a building area in which a three-dimensional object is built, and a collecting apparatus that cleans the air sucked out through the exhaust duct.

### CROSS REFERENCE TO RELATED APPLICATIONS

This application claims the priority benefit of Japanese Patent Application No. 2017-180219, filed on Sep. 20, 2017. The entirety of the above-mentioned patent application is hereby incorporated by reference herein and made a part of this specification.

### TECHNICAL FIELD

The present disclosure relates to a building apparatus and a collecting apparatus that build a three-dimensional object having a three-dimensional shape.

### BACKGROUND ART

In recent years, a 3D printer for building a three-dimensional object having a three-dimensional shape has been used in various uses. The 3D printer is a device for making a three-dimensional object a target product by sequentially forming and depositing a large number of layers.

In an ink-jet 3D printer, curable ink as a material of a three-dimensional object is ejected from an ejection head toward a stage based on a design data of the three-dimensional object. By curing the curable ink dropped on the stage or on a layer that has been already formed on the stage, a layer is formed. For example, in a case of using UV curable ink, the ink is cured by being irradiated with ultraviolet rays immediately after the ink is ejected. After one layer is formed, the stage is lowered down, and a new layer is formed on the formed layer (Patent Literature 1). Accordingly, a three-dimensional object can be built on the stage.
Patent Literature 1: Japanese Unexamined Patent Publication No. 2005-59289
Patent Literature 2: Japanese Unexamined Patent Publication No. 2014-148131

### SUMMARY

In the building apparatus of the three-dimensional object as described above, the stage is successively lowered down as building process progresses, and a gap between the ejection head and the stage becomes larger. The gap is needed to place a three-dimensional object to be manufactured on the stage. However, the present inventor has found that the building apparatus that requires such a gap may have a problem different from the case of performing printing on printed matter such as a paper medium.

The ink ejected from the ejection head is typically landed on a target position, but part of the ejected ink may be caused to be in a mist state. In an ink-jet recording device that performs printing on printed matter such as a paper medium, a gap between the ejection head and the printed matter is small, so that a mist of ink adheres to the printed matter. In the building apparatus of a three-dimensional object, by contrast, the gap between the ejection head and the stage is larger, so that a mist of ink may float in a region of the gap, and ink deviated from a landed position may adhere to a position that is not a correct position or remain in the space for a long time.

When such a mist of ink or ink deviated from the landed position adheres to the three-dimensional object, appearance of the three-dimensional object may be colored in an unintended color. Furthermore, uncured ink diffused to the outside of the apparatus may cause an allergic reaction in an operator.

Thus, the present disclosure provides a building apparatus and a collecting apparatus that can collect ink or mist thereof that may remain in a building area.

Patent Literature 2 discloses an ink-jet recording device that guides an organic solvent to a decomposing apparatus using an air-blowing fan. However, the ink-jet recording device disclosed in Patent Literature 2 is an apparatus that performs printing on a two-dimensional medium, which guides the organic solvent to the decomposing apparatus to prevent ink from bleeding on printed matter. That is, the solvent is prevented from being saturated and retained near a surface of the printed matter (Patent Literature 2, paragraphs 0002 and 0003).

A building apparatus according to the present disclosure for building a three-dimensional object has an ejection head configured to eject a curable ink and is configured to build the three-dimensional object by ejecting the curable ink from the ejection head. The building apparatus according to the present disclosure includes: a stage being opposed to the ejection head and the curable ink ejected from the ejection head is landed on the stage to build the three-dimensional object; a moving member that moves the stage and the ejection head relatively to each other to be separated from each other as performing a building progress of the three-dimensional object; an exhaust duct that sucks out an air from a building area in which the ejection head and the stage are opposed to each other and the three-dimensional object is built; and a collecting apparatus that cleans the air sucked out through the exhaust duct.

In the building apparatus, part of the curable ink ejected from the ejection head floats in the building area in some cases. In a case in which the stage and the ejection head move relatively to each other to be separated from each other as building of the three-dimensional object progresses, a space between the ejection head and the stage gradually becomes larger. With the configuration of the present disclosure, air is sucked out from the building area to collect curable ink floating in the building area, so that mist, ink droplets, or dust (powder building) retained in the building area of the building apparatus can be prevented from being retained in a building space and adhering to the three-dimensional object to stain the surface of the three-dimensional object.

In the building apparatus according to the present disclosure, an exhaust port of the exhaust duct may be configured to be positioned above the uppermost surface of the three-dimensional object. By causing the air in the building area to flow upward from below, mist, ink droplets, or dust (powder building) can be made difficult to approach the three-dimensional object in the building area. That is, a point where the mist and the like are generated is between a nozzle face and the three-dimensional object, so that, when the exhaust port is arranged above the uppermost surface of the three-dimensional object, the mist and the like can be made difficult to approach the three-dimensional object in the building area.

The building apparatus according to the present disclosure may use, as the curable ink, an UV curable ink that is cured by an ultraviolet ray. Although the UV curable ink has a distinctive smell, the smell can be reduced by sucking out the UV curable ink floating in the building area with the configuration of the present disclosure. Accordingly, for example, the building apparatus can be comfortably used even in a small room.

In the building apparatus according to the present disclosure, the collecting apparatus may be arranged on a rear side of a main body of the building apparatus opposite to a side on which an operation to the main body of the building apparatus is performed, and the exhaust duct may connect the collecting apparatus with the building area through a rear surface of the building apparatus. In this way, by arranging the collecting apparatus behind the main body of the building apparatus, the collecting apparatus can be made inconspicuous, and does not interfere with the operation.

In the building apparatus according to the present disclosure, the collecting apparatus may have a filter that traps fine particles. With this configuration, the curable ink, the mist thereof, and the like can be removed from the collected air to clean the air around the building apparatus.

In the building apparatus according to the present disclosure, the exhaust port may be directed to a space through which a nozzle face of the ejection head passes. With this configuration, the air is exhausted from the space through which the nozzle face as a generation source of the curable ink, the mist thereof, and the like floating in the building area passes, so that the curable ink, the mist thereof, and the like floating in the building area can be collected before being diffused toward the three-dimensional object.

In the building apparatus according to the present disclosure, the exhaust port may have a long and narrow shape extending along a Y-bar that supports the ejection head in a movable manner. With this configuration, due to the exhaust duct including the exhaust port having a shape along a movement track of the ejection head, the mist of the curable ink ejected from the ejection head can be appropriately collected even when the ejection head moves.

A collecting apparatus according to the present disclosure for sucking out an air from a building area in which a three-dimensional object is built, configured to be attached to a building apparatus for building the three-dimensional object that has an ejection head configured to eject a curable ink and is configured to build the three-dimensional object by ejecting the curable ink from the ejection head. The collecting apparatus according to the present disclosure includes: an exhaust duct for sucking out the air from a building area in which the ejection head and the stage are opposed to each other and the three-dimensional object is built; and a filter that cleans the air sucked out through the exhaust duct, wherein an exhaust port of the exhaust duct has a long and narrow shape extending along a Y-bar that allows the ejection head to move.

With this configuration, due to the exhaust duct including the exhaust port having a shape along a movement track of the ejection head, the curable ink or the mist thereof floating in the building area can be appropriately collected even when the ejection head moves.

The building apparatus according to the present disclosure sucks out the air from the building area, so that the curable ink floating in the building area can be collected.

### BRIEF DESCRIPTION OF THE DRAWINGS

FIG. 1 is a diagram illustrating a configuration of a building apparatus according to an embodiment.

FIG. 2 is a diagram illustrating a configuration of a building apparatus main body.

FIG. 3A is a perspective view illustrating a distal end member of an exhaust duct.

FIG. 3B is a plan view illustrating the distal end member of the exhaust duct.

FIG. 4 is a cross-sectional view of the building apparatus main body viewed from a side surface.

FIG. 5 is a perspective view illustrating part of the building apparatus without a housing.

FIG. 6 is a diagram illustrating a configuration of a collecting apparatus.

FIG. 7 is a diagram illustrating a flow of air that is generated in a building area when an ejection head moves.

### DESCRIPTION OF EMBODIMENTS

The following describes a building apparatus 1 according to an embodiment of the present disclosure with reference to the drawings. In the present embodiment, exemplified is an apparatus for building a three-dimensional object using UV curable ink. The building apparatus according to the present disclosure can also be applied to a building apparatus that uses thermoplastic curable ink, other than the UV curable ink, that is softened at a higher temperature than the ordinary temperature and cured at the ordinary temperature. The building apparatus according to the present disclosure can also be applied to a building apparatus using powder lamination method, and can remove dust generated in the powder lamination method.

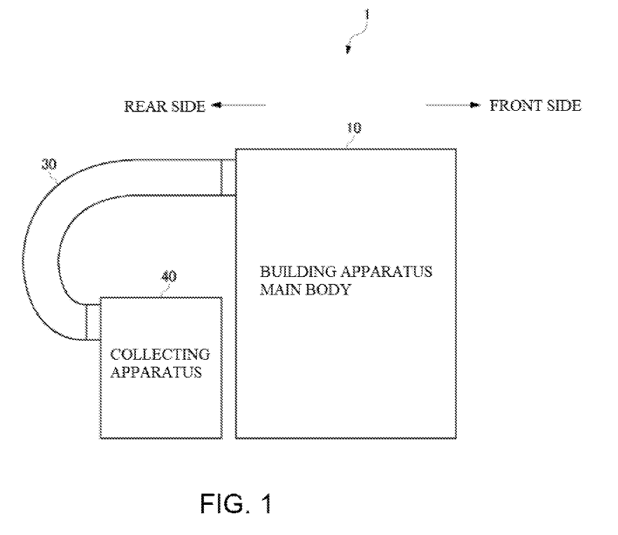

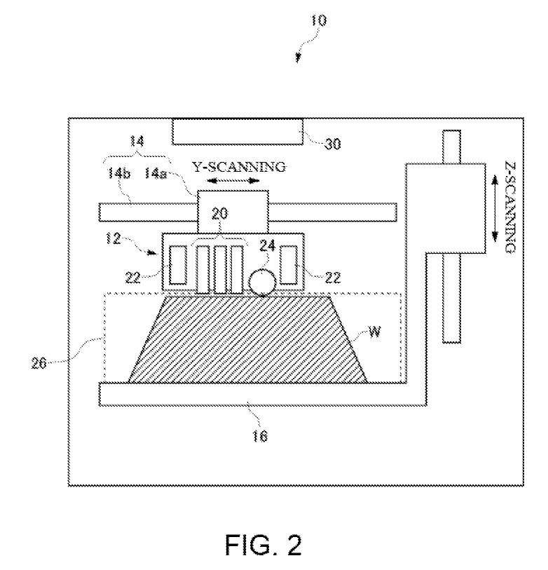

FIG. 1 is a diagram illustrating a configuration of the building apparatus 1 according to the present embodiment. The building apparatus 1 includes a building apparatus main body 10, and a collecting apparatus 40 connected to the building apparatus main body 10. As illustrated in FIG. 2, the building apparatus main body 10 is an apparatus that builds a three-dimensional object W by repeatedly performing processing of ejecting UV curable ink from an ejection head 20 to form a layer based on design data of the three-dimensional object W. In the present embodiment, for convenience of explanation, an apparatus for building the three-dimensional object W is called a “building apparatus main body”, and the building apparatus main body 10 and the collecting apparatus 40 are collectively called a “building apparatus”.

The collecting apparatus 40 has a function of sucking out air from the inside of a housing of the building apparatus main body 10 to be cleaned. The building apparatus main body 10 is connected to the collecting apparatus 40 through an exhaust duct 30. The collecting apparatus 40 is arranged behind the building apparatus main body 10 to be prevented from interfering with an operation and the like on the building apparatus main body 10. By arranging the collecting apparatus 40 behind the building apparatus main body 10, the collecting apparatus 40 can be made inconspicuous.

FIG. 2 is a diagram illustrating a configuration of the building apparatus main body 10. The building apparatus main body 10 is an ink jet 3D printer that cures the UV curable ink jetted from the ejection head 20 by ultraviolet rays to be laminated. The building apparatus main body 10 includes an ejection unit 12, a main scanning driver 14, and a stage 16. The ejection unit 12 is a portion for ejecting droplets (ink droplets) of the UV curable ink as a material of the three-dimensional object W. The building apparatus main body 10 is not limited to a system of using the UV curable ink, and may have a system of laminating a thermoplastic curable resin that is jetted from the ejection head 20 in a high temperature state and cooled to the ordinary temperature to be cured.

The ejection unit 12 includes the ejection head 20 that ejects colored ink and colorless ink or ink containing a supporting material, a UV light source 22 that cures the ejected ink, and a flattening roller 24 that flattens a lamination surface of the curable resin formed during when the three-dimensional object W is built. Herein, exemplified is a case in which the ejection head 20 houses three pieces of ink, but the number of pieces of ink housed in the ejection head 20 can be an appropriate number.

The ejection unit 12 forms, for example, each layer constituting the three-dimensional object W by ejecting and curing ink droplets and the like of the curable resin to be cured by being irradiated with ultraviolet rays. Specifically, the ejection unit 12 ejects ink droplets in accordance with an instruction from a control unit (not illustrated) to repeatedly perform, multiple times, a layer forming operation of forming a layer of the curable resin and a curing operation of curing the layer of the curable resin formed through the layer forming operation. Accordingly, the ejection unit 12 forms a plurality of layers of cured curable resin overlapping with each other.

The main scanning driver 14 is a driver that causes the ejection unit 12 to perform the main scanning operation. Herein, the main scanning operation is, for example, an operation of ejecting ink droplets while moving in a main scanning direction (Y-scanning in the drawing) set in advance.

The main scanning driver 14 includes a carriage 14a and a Y-bar 14b. The carriage 14a is a supporting part that supports the ejection unit 12 to be opposed to the stage 16. That is, the carriage 14a supports the ejection unit 12 so that an ejecting direction of ink droplets directs toward the stage 16. At the time of main scanning operation, the carriage 14a moves along the Y-bar 14b while supporting the ejection unit 12. The Y-bar 14b is a rail-like member that guides movement of the carriage 14a and causes the carriage 14a to move in accordance with an instruction from the control unit at the time of main scanning operation.

Movement of the ejection unit 12 in the main scanning operation may be movement relative to the three-dimensional object W. For example, by fixing the position of the ejection unit 12 and causing the stage 16 to move, the three-dimensional object W may be moved.

The three-dimensional object W being built is placed on the stage 16. The stage 16 has a function of causing an upper surface to move in a vertical direction (Z-direction in the drawing) and causes the upper surface to move as building of the three-dimensional object W progresses in accordance with an instruction from the control unit. Due to this, a distance (gap) between the ejection unit 12 and a surface to be built of the three-dimensional object W in the middle of building is appropriately adjusted. The surface to be built of the three-dimensional object W is, for example, a surface on which the next layer is formed by the ejection unit 12.

The building apparatus main body 10 may further include, for example, various configurations required for building or coloring the three-dimensional object W in addition to the configuration illustrated in FIG. 2. For example, the building apparatus main body 10 may further include a sub scanning driver and the like that causes the ejection unit 12 to perform a sub scanning operation. The sub scanning operation is, for example, an operation of causing the ejection head 20 of the ejection unit 12 to move in a sub scanning direction orthogonal to the main scanning direction relatively to the three-dimensional object W being built. The sub scanning driver causes the ejection unit 12 to perform the sub scanning operation as needed, for example, in a case of building the three-dimensional object W having a length in the sub scanning direction longer than a building width of the ejection head 20 in the ejection unit 12. The sub scanning driver may be, for example, a driver that causes the Y-bar 14b to move together with the carriage 14a that holds the ejection unit 12.

The ejection unit 12, the main scanning driver 14, the stage 16, and the like described above are housed in the housing of the building apparatus main body 10. Herein, in an internal space of the building apparatus main body 10, a space for building the three-dimensional object W in which the ejection head 20 is opposed to the stage 16 is called a “building area 26”. Above the building area 26, the ejection unit 12 for performing building, the main scanning driver 14, and the like are configured.

The building apparatus main body 10 according to the present embodiment includes the exhaust duct 30 arranged above the uppermost surface of the three-dimensional object W. Specifically, the exhaust duct 30 is arranged above the main scanning driver 14.

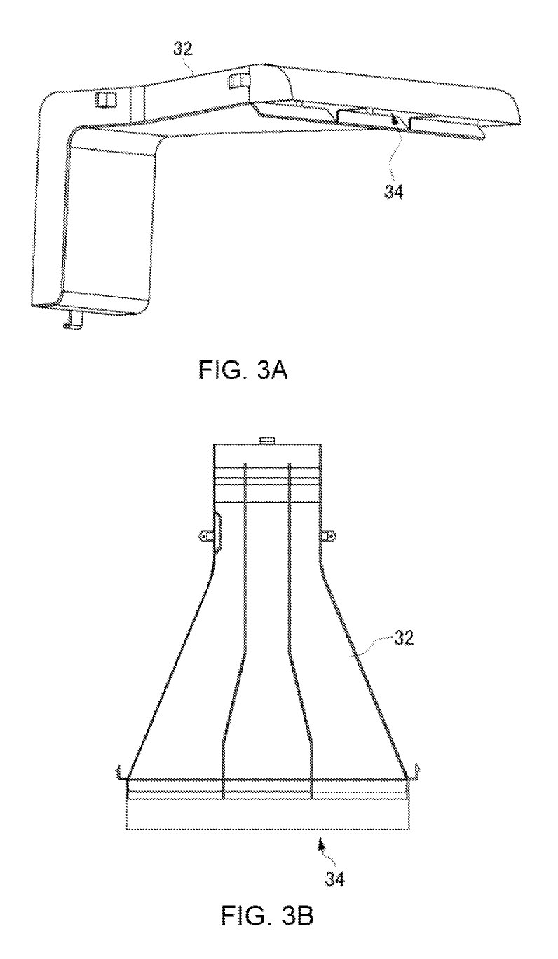

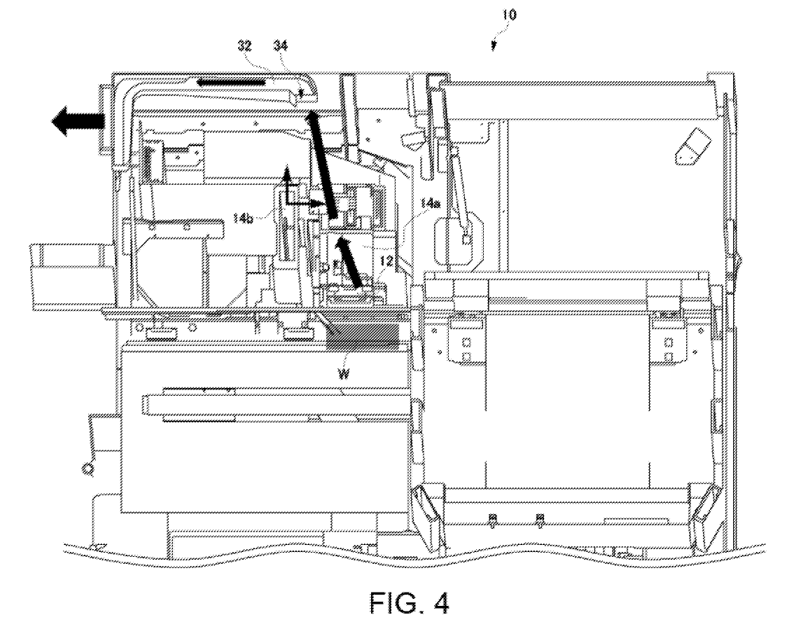

FIG. 3A is a perspective view illustrating appearance of a distal end member 32 near an exhaust port 34 of the exhaust duct 30, and FIG. 3B is a plan view of the distal end member 32 viewed from above. FIG. 4 is a cross-sectional view of the building apparatus main body 10 viewed from a side surface. FIG. 4 is an explanatory diagram for illustrating an attaching position of the distal end member 32 and a flow of air, and a configuration that is not directly related to the description is appropriately omitted.

The distal end member 32 is part of the exhaust duct 30, and is a portion arranged inside the building apparatus main body 10. As illustrated in FIG. 4, the distal end member 32 is bent at a substantially right angle to be brought into contact with a back surface from a roof in the building apparatus main body 10. As illustrated in FIG. 3B, the distal end member 32 is widened toward the exhaust port 34. As illustrated in FIG. 3A, the exhaust port 34 opens downward, and has a long and narrow shape extending along the Y-bar 14b that supports the carriage 14a in a movable manner. That is, the exhaust port 34 is directed to the space through which the nozzle face of the ejection head 20 passes, so that the exhaust port 34 can suck out air from the space (refer to FIG. 4). The exhaust port 34 is preferably arranged above the Y-bar 14b. Accordingly, an air current caused by exhaustion flows upward, so that influence on a trajectory of the ink ejected from the ejection head 20 is small. The shape of the exhaust port 34 does not necessarily cover the entire moving range of the carriage 14a, and may cover part of the moving range of the carriage 14a. In the present embodiment, the exhaust port 34 is arranged above the Y-bar 14b by way of example. However, the exhaust port 34 is not necessarily positioned above the Y-bar 14b, and may be arranged behind the building area 26.

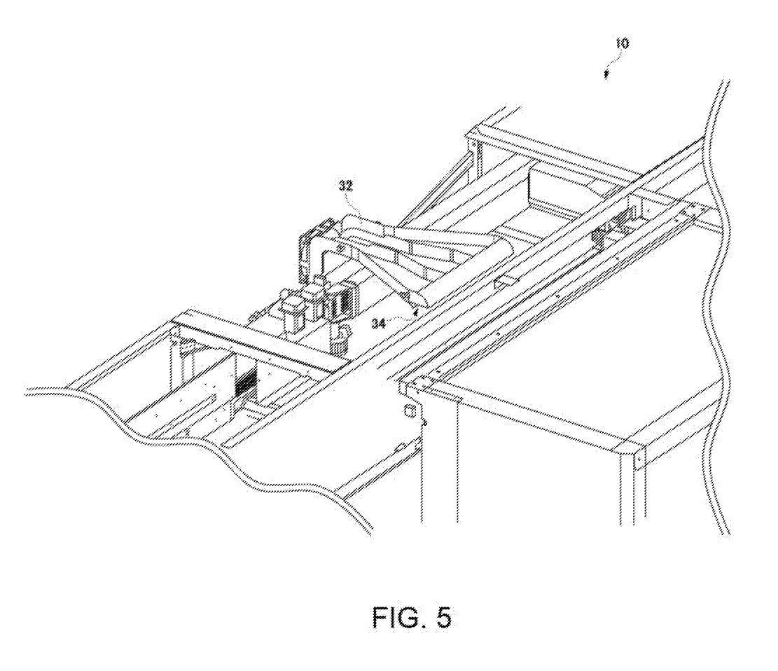

FIG. 5 is a perspective view of the building apparatus 1 that is partially omitted for illustrating the attaching position of the distal end member 32. The exhaust port 34 of the distal end member 32 is arranged to look down the space in which the carriage 14a moves. In FIG. 5, an upper surface of the distal end member 32 is omitted. As illustrated in FIG. 5, an inner space of the distal end member 32 is divided into three flow channels. Because the flow channels are divided in this way, air sucking force can be equalized in a longitudinal direction of the exhaust port 34.

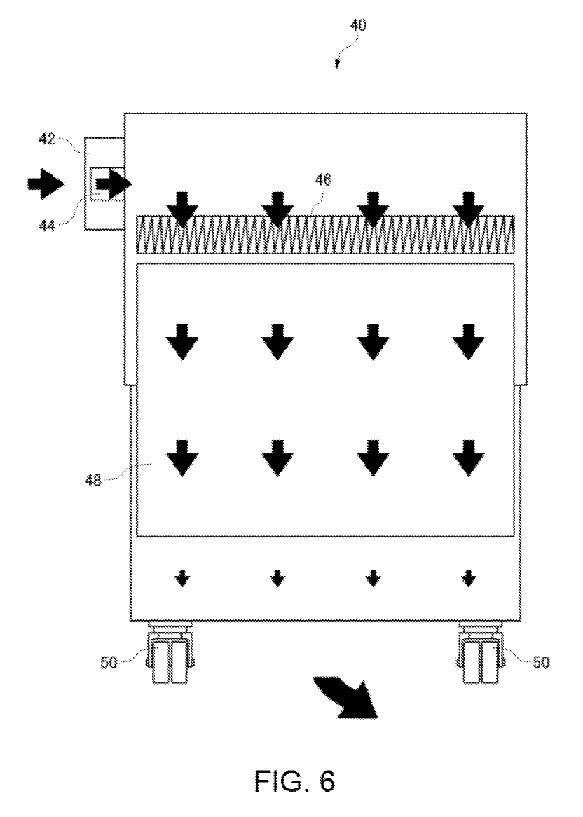

FIG. 6 is a cross-sectional view illustrating a configuration of the collecting apparatus 40. The collecting apparatus 40 includes a prefilter 44, a high efficiency particulate air (HEPA) filter 46, and a chemical filter 48 to clean air taken in from a connection port 42 to which the exhaust duct 30 is connected. The HEPA filter 46 is a filter that removes fine particles such as dirt and dust from the air to be clean air. The chemical filter 48 is a filter that removes a minute amount of chemical substances, a malodorous component, and the like from the air. The collecting apparatus 40 sucks in the air with a fan (not illustrated), and causes the air to pass through the HEPA filter 46 and the chemical filter 48 to clean the air. The collecting apparatus 40 discharges the cleaned air from a lower part of the apparatus. The collecting apparatus 40 includes casters 50 and can be easily moved. The building apparatus 1 according to the present disclosure has been described above.

### Effect of Present Embodiment

(1) The building apparatus 1 according to the present embodiment includes the ejection head 20 that ejects UV curable ink and builds the three-dimensional object W by ejecting the UV curable ink from the ejection head 20. The building apparatus according to the present embodiment includes: the stage 16 opposed to the ejection head 20 on which the UV curable ink 20 ejected from the ejection head 20 is landed to build the three-dimensional object W; a moving member that moves the stage 16 and the ejection head relatively to each other to be separated from each other as building of the three-dimensional object W progresses; an exhaust duct 30 that sucks out air from the building area 26 in which the ejection head 20 and the stage 16 are opposed to each other and the three-dimensional object W is built; and a collecting apparatus 40 that cleans the air sucked out through the exhaust duct 30.

Ejected droplets of the UV curable ink that are smaller than normal from the ejection head 20 may become mist, and may float in the building area 26 without landing on a surface to be laminated of the three-dimensional object W. Due to movement of the ejection head 20 that moves to the left and the right on the Y-bar 14b, a flow of air is generated in the building area 26, and ink mist may adhere to a built portion of the three-dimensional object W.

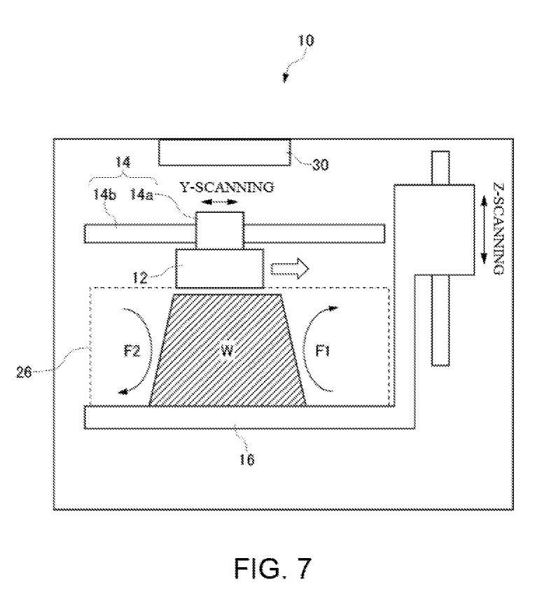

FIG. 7 illustrates a flow of air generated in the building area 26 when the ejection head 20 moves in a right direction in FIG. 7. In the example illustrated in FIG. 7, an air current F1 that moves upward from below is generated on the right side of the three-dimensional object W, and an air current F2 that moves downward from above is generated on the left side of the three-dimensional object W. Thus, on the right side of the three-dimensional object W, a direction or speed of the ink is disturbed by F1, the ink flying downward from the head to constitute a right side end. As a result, the ink is not landed on the right side end of the three-dimensional object W, floats in a space on a further right side to be diffused, and adheres to the inside of the apparatus. On the left side of the three-dimensional object W, the ink mist generated near the nozzle face of the ejection head 20 is carried by the downward air current F2 toward the three-dimensional object W, and may adhere to a built portion of the three-dimensional object W. Due to this event, when the ink mist adheres to an unexpected portion, external coloring of the three-dimensional object W may be affected. The exhaust port 34 of the distal end member 32 is arranged above the uppermost surface of the three-dimensional object W, and the air is sucked in through the exhaust port 34 from a space near the nozzle face of the ejection head 20 (refer to FIG. 4), so that the ink mist can be prevented from going down to the building area 26.

When the ink mist before cured by ultraviolet rays diffuses to the outside of the apparatus, an allergic reaction is caused in an operator in some cases. In a case in which the ink mist adhering to the three-dimensional object W is cured, coloring may be affected as described above. However, in a case in which the ink mist is not cured and remains as it is, an allergic reaction may be caused when the operator takes out or cleans the three-dimensional object W. The building apparatus 1 according to the present embodiment can collect the ink mist that may be contained in the air by sucking out the air from the building area 26.

(2) In the building apparatus 1 according to the present embodiment, the exhaust port 34 of the exhaust duct 30 may be configured to be positioned above the uppermost surface of the three-dimensional object W. Accordingly, by causing the flow of air in the building apparatus main body 10 to be upward from below, the mist, a satellite, and the like can be caused to hardly approach the three-dimensional object within the building area 26. That is, because a generation point of the mist and the like is between the nozzle face and the three-dimensional object, arranging the exhaust port 34 above the uppermost surface of the three-dimensional object W makes the mist and the like difficult to approach the three-dimensional object W within the building area 26.

(3) The building apparatus 1 according to the present embodiment uses, as the curable ink, the UV curable ink that is cured by ultraviolet rays, but the UV curable ink has a distinctive smell. The ink ejected at a high temperature inside the apparatus especially generates a strong smell in some cases. With the configuration according to the present embodiment, the smell can be reduced by sucking out the mist of UV curable ink from the building area 26. Depending on a use environment, the building apparatus 1 may be used in an office and the like. Even in such a case, the building apparatus 1 can be comfortably used.

(4) In the present embodiment, the collecting apparatus 40 is arranged on a rear side opposite to a side on which an operation to the building apparatus main body 10 is performed, and the exhaust duct 30 connects the collecting apparatus 40 with the inside of the building apparatus main body 10 including the building area 26 through a rear surface of the building apparatus 1. In this way, by arranging the collecting apparatus 40 behind the main body of the building apparatus 1, the collecting apparatus 40 can be prevented from being conspicuous. The collecting apparatus 40 can also be prevented from interfering with the operation.

(5) In the building apparatus 1 according to the present embodiment, the collecting apparatus 40 includes the HEPA filter 46 that traps fine particles, and the chemical filter 48 that removes a minute amount of chemical substances, a malodorous component, and the like from the air. With this configuration, the mist of UV curable ink can be removed from the collected air, and the air can be cleaned and discharged to the outside.

(6) In the building apparatus 1 according to the present embodiment, the exhaust port 34 may be directed to the space through which the nozzle face of the ejection head 20 passes. With this configuration, the air is exhausted from the space through which the nozzle face as a generation source of the mist of UV curable ink passes, so that the ink mist can be collected before being diffused toward the three-dimensional object W.

(7) In the building apparatus 1 according to the present embodiment, the exhaust port 34 has a long and narrow shape extending along the Y-bar 14b that supports the ejection head 20 in a movable manner. With this configuration, due to the exhaust duct 30 including the exhaust port 34 having a shape along a movement track of the ejection head 20, the mist of curable ink ejected from the ejection head 20 can be appropriately collected even when the ejection head 20 moves.

(8) The collecting apparatus 40 according to the present embodiment includes the exhaust duct 30 for sucking out the air from the building area 26, and the HEPA filter 46 and the chemical filter 48 for cleaning the air sucked out through the exhaust duct 30. The exhaust port 34 of the exhaust duct 30 has a long and narrow shape extending along the Y-bar 14b that allows the ejection head 20 to move.

With this configuration, the air is sucked in through exhaust duct 30 including the exhaust port 34 having a shape along the movement track of the ejection head 20, so that the ink mist of UV curable ink ejected from the ejection head 20 can be appropriately collected even when the ejection head 20 moves.

### INDUSTRIAL APPLICABILITY

The present disclosure is useful as a building apparatus and the like for building a three-dimensional object.

What is claimed is:

1. A building apparatus for building a three-dimensional object, and the building apparatus has an ejection head configured to eject a curable ink and is configured to build the three-dimensional object by ejecting the curable ink from the ejection head, the building apparatus comprising:
a stage, being opposed to the ejection head, and the curable ink ejected from the ejection head is landed on the stage to build the three-dimensional object;
a moving member, being configured to move the stage and the ejection head relatively to each other to be separated from each other as performing a building progress of the three-dimensional object;
an exhaust duct, being configured to suck out an air from a building area in which the ejection head and the stage are opposed to each other and the three-dimensional object is built; and
a collecting apparatus, being configured to clean the air sucked out through the exhaust duct.

2. The building apparatus according to claim 1, wherein
an exhaust port of the exhaust duct is positioned above an uppennost surface of the three-dimensional object.

3. The building apparatus according to claim 1, wherein
an UV curable ink to be cured by an ultraviolet ray is used as the curable ink.

4. The building apparatus according to claim 1, wherein
the collecting apparatus is arranged on a rear side of a main body of the building apparatus opposite to a side on which an operation to the main body of the building apparatus is performed, and
the exhaust duct connects the collecting apparatus with the building area through a rear surface of the building apparatus.

5. The building apparatus according to claim 1, wherein
the collecting apparatus includes a filter, being configured to trap fine particles.

6. The building apparatus according to claim 1, wherein
the exhaust port is directed to a space through which a nozzle face of the ejection head passes.

7. The building apparatus according to claim 1, wherein
the exhaust port has a long and narrow shape extending along a Y-bar that supports the ejection head in a movable manner.

8. A collecting apparatus for sucking out an air from a building area in which a three-dimensional object is built, configured to be attached to a building apparatus for building the three-dimensional object that has an ejection head configured to eject a curable ink and is configured to build the three-dimensional object by ejecting the curable ink from the ejection head, the collecting apparatus comprising:
an exhaust duct, being configured to suck out the air from the building area in which the ejection head and the stage are opposed to each other and the three-dimensional object is built; and
a filter, being configured to clean the air sucked out through the exhaust duct, wherein
an exhaust port of the exhaust duct has a long and narrow shape extending along a Y-bar that allows the ejection head to move.
